(19) United States
(12) Patent Application Publication
(10) Pub. No.: US 2009/0093390 A1
(43) Pub. Date: Apr. 9, 2009

(54) Thickened Methyl Ester Microemulsions for Cleaning Hard Surfaces

(75) Inventors: Stephen F. Gross, Souderton, PA (US); John Hessel, Doylestown, PA (US); Timothy C. Morris, Morton, PA (US)

Correspondence Address: FOX ROTHSCHILD LLP, 2000 MARKET STREET, 10th Floor, PHILADELPHIA, PA, 19103, US

(73) Assignee: COGNIS IP MANAGEMENT GMBH, Duesseldorf (DE)

(21) Appl. No.: 12/245,643

(22) Filed: Oct. 3, 2008

Related U.S. Application Data
(60) Provisional application No. 60/977,093, filed on Oct. 3, 2007.

(51) Int. Cl. C09D 9/04; C11D 17/08

(52) U.S. Cl. 510/174; 510/203

(57) ABSTRACT

A hard surface cleaning composition, particularly useful for cleaning vertical or other surfaces where superior surface cling is important and preferably in the form of an oil-continuous microemulsion, comprising one or more primary solvents, one or more polar solvents, and one or more primary emulsifiers, one or more secondary emulsifiers, one or more co-surfactants, one or more thickeners, water, and, optionally, one or more auxiliary additives.

### RELATED APPLICATIONS

The present application is related to and claims the priority benefit of provisional application 60/977093, filed Oct. 3, 2007, which is incorporated herein in its entirety by reference as if fully set forth.

### BACKGROUND OF THE INVENTION

1. Field of the Invention

The present invention relates to cleaning compositions for cleaning hard surfaces.

2. Background and Related Art

The removal of graffiti, undesirable aged paints, polyurethane, other coatings, greases, printing ink, and the like from various substrates has been an objective of cleaning compositions for many years, especially when coating over these substrates has not been a viable option due to the high likelihood of “bleed through” or interference with subsequent coating adhesion by the previous undesirable elements. When it has worked, removal has been generally accomplished by two mechanisms: dissolution and lifting. The dissolution mechanism generally occurs when the undesirable material is dissolved from the substrate by a solvent in the cleaning solution. The lifting mechanism generally occurs when such a solvent penetrates into the undesirable material and causes it to swell, resulting in the material, whether it is a paint, another coating or similar undesirable substance, wrinkling and/or lifting (separating) from the substrate, allowing it to then be more easily removed from the surface of the substrate.

Oil-continuous methyl ester microemulsions are known to be safe and effective graffiti removers, paint strippers, adhesive removers, degreasers and printing ink removers. See, for example, U.S. Pat. Nos. 5,871,666 (Gross), 5,952,287 (Gross et al), 5,990,072 (Gross et al), 6,224,685B1 (Gross et al), 6,982,244B2 (Gross et al), and 7,018,969 (Gross et al), which disclose terpene-free microemulsion compositions for cleaning hard surfaces. Such microemulsions are generally quite thin, thus reducing their effectiveness for removing graffiti, adhesives and other undesired soils and materials from vertical surfaces, as the dwell time of such microemulsions on such surfaces is generally not sufficient for effective removal.

Attempting to combat this problem, adding thickening agents to microemulsion cleaning compositions has been difficult. Efforts to adopt thickeners, such as surfactant thickeners, colloidal thickeners, and hydrophobically-modified cellulosic gums, which have been used with various aqueous solutions, have not been very successful. Surfactants directly affect the hydrophilicity of the microemulsion's emulsifier system, tending to produce destabilization of otherwise-optimized formulations; colloidal thickeners generally result in loss of the normal transparency of microemulsion compositions as well as in sedimentation of the colloidal particles; and modified cellulosic gums, which have been found to thicken oil-continuous methyl ester microemulsions, frequently cause an undesirable hazy appearance of the microemulsions, and in many cases eventually precipitate out of the microemulsion.

Dibasic esters are also known for their use as solvents in compositions for applying antioxidants to certain substrates, for example, polymeric textile substrates. See U.S. Pat. No. 6,368,358B1 (Glenn et al). Dibasic esters have also been uses in microemulsions for cleaning hard surfaces. See Published U.S. Patent Application 2007/0093404A1 (Gross et al).

In view of the above noted problems with prior materials, applicants have developed cleaning compositions and methods that ameliorate one or more of the disadvantages noted above.

### BRIEF SUMMARY OF THE INVENTION

One aspect of the present invention relates to cleaning compositions that have desirable cleaning properties, and in certain preferred embodiments have features and characteristics that provide desirable performance on vertical and other surfaces where the dwell time that the composition would otherwise be expected to spend on the surface to be cleaned would be problematic for prior formulations. Moreover, in certain aspects of such embodiments, the present compositions not only exhibit desirable cleaning performance, and in some cases dramatically superior cleaning performance, the preferred compositions also possess the feature of being relatively easily rinsed off the surface when the cleaning is s completed. Another advantage of certain aspects of the present invention is that the cleaning composition is not only especially effective, even for hard surfaces, particularly vertical ones, but such compositions have the further advantage of relatively low formulation costs.

According to one aspect, the present invention provides a microemulsion cleaning composition comprising: (a) a primary ester solvent; (b) one or more polar solvents, preferably that have limited water solubility(ies) of from about 1 g/100 ml to about 5 g/100 ml; and (c) water in an amount to achieve a ratio, by weight, of primary solvent:water in the composition of from about 1:5 to about 1:1, more preferably in certain embodiments of from about 1:2 to about 1:2.5.

Although applicants do not intend to be bound by or to any particular theory of operation, is believed that the superior surface cling exhibited by certain aspects of the present compositions, without in many cases sacrifice to the cleaning efficacy, stability and appearance of such compositions, is achieved by replacing or substituting at least a portion of the ester solvent that was included in many of the prior art compositions, particularly the methyl, dibasic and/or acetate ester microemulsion, with the polar solvent of the present invention. The present compositions thus possess in certain preferred embodiments an increased amount of aqueous internal phase, and a decrease the amount of the continuous organic phase in order to maintain the same volume of composition. It is believed that this reduction in the oil:water ratio in the composition has advantageous effects, without negatively affecting the thermal stability of the oil-continuous emulsions.

One preferred aspect of the present invention involves compositions which comprise, in addition to the components mentioned above, a thickener comprising cellulosic gum, preferably a hydrophobically-modified cellulosic gum compound. In certain of such preferred embodiments, applicants have found that the present compositions possess the duel benefits of enhancing or facilitating complete or substantially complete solubilization of the cellulosic gum as well as reducing the total amount of emulsifiers required to form a stable emulsion. One aspect of the present invention thus provides a cleaning composition, preferably in the form of an oil-continuous microemulsion, comprising one or more primary, preferably weakly-polar solvents, one or more polar solvents, one or more emulsifiers, one or more co-surfactants, one or more thickeners, water, and, optionally, one or more auxiliary additives.

The preferred stable, viscous compositions, with a reduced solvent phase, may then be employed in a wide variety of cleaning methods, including in a liquid or spray that would be particularly effective in a process for cleaning vertical hard surfaces or other surfaces where surface cling and a longer dwell time are desirable. Such a processes for cleaning surface substrates, preferably hard substrates, and even more preferably hard substrates forming or having a vertical surface, would involve contacting the substrate with a cleaning-effective amount of one or more of the cleaning compositions in accordance with the present invention.

### DETAILED DESCRIPTION OF PREFERRED EMBODIMENTS

Other than in the operating Examples, all numbers expressing quantities of ingredients or reaction conditions used herein are to be understood as being modified in all instances by the term “about”, and, unless otherwise indicated, when an amount or percentage is identified as “by weight”, it is to be interpreted as being based on the weight of the total composition involved.

The removal of undesirable materials from vertical substrates is likely to require the use of a cleaning composition capable of some degree of vertical surface cling. Special formulation techniques are required in order to formulate methyl, dibasic and/or acetate ester compositions, in this case, microemulsions, to accommodate thickeners, as most thickeners are designed to function in either highly polar or non-polar solvents, rather than the weakly-polar ester solvent, such as methyl esters, dibasic esters, or acetate esters, in the microemulsions of the present invention. With weakly-polar solvents, there are limited viable options.

In accordance with certain preferred embodiments of the present invention, particularly those embodiments in which it is desirable to provide and prepare cleaning compositions which comprise microemulsions that incorporate one or more thickening agents, the preferred solvent phase of the present invention comprises a combination of: (i) at least one weakly polar solvent, preferably at least one ester solvent, and even more preferably at least one alkyl ester solvent; and (ii) at least one relatively more polar solvent than the relatively weekly polar solvent, such as, for example; alcohols, preferably aromatic alcohols, such as benzyl alcohol, and/or alkyl alcohols, such as1-hexanol; glycols, preferably alkene glycols, and even more preferably ethylene glycol; ethers, preferably aromatic ethers, such as phenyl ethers and propylene glycol phenyl ether; and combinations of two or more of these. In certain embodiments, however, for example for those in which the thickener comprises, and preferably consists essentially of, one or more cellulosic gum thickeners, this combination of solvents may not be as effective as desired to achieve complete or substantially complete solubility. Especially in such embodiments, it is preferred, and in some embodiments deemed to be necessary, to increase the amount of the aqueous internal phase, thereby decreasing the amount of continuous solvent phase. In many preferred embodiments these techniques together are effective to achieve substantially complete solubility of the cellulosic gum thickener in the finished microemulsion, as well as in a reduction in the total amount of emulsifiers required to form a stable microemulsion.

In certain preferred embodiments, the cleaning composition of the invention comprises:
(a) from 3%-to-50%, preferably 15%-to-25%, by weight, in the aggregate, of one or more primary solvents, preferably relatively weekly polar solvents, even more preferably C₆-C₁₈ primary, relatively weekly polar solvents, such as those solvents selected from the group consisting of C₆-C₁₈ methyl esters, C₆-C₁₈ dibasic esters, and C₆-C₁₈ acetate esters and combinations of two or more of these;
(b) from 3%-to-15%, preferably 5%-to-10%, by weight, in the aggregate, of one or more solvents which are more polar than the relatively weekly polar solvents in (a);
(c) optionally, but preferably, from 1%-to-15%, preferably 7%-to-10%, by weight, in the aggregate, of one or more primary emulsifiers;
(d) optionally, but preferably, from 1%-to-5%, preferably 1.9%-to-3.6%, by weight, in the aggregate, of one or more secondary emulsifiers;
(e) optionally, but preferably, from 1%-to-15%, preferably 7%-to-10%, by weight, in the aggregate, of one or more short-chain co-surfactants;
(f) optionally, but preferably, from 0.1%-to-2%, preferably 0.2%-to-0.5%, by weight, in the aggregate, of one or more thickeners;
(g) optionally, but preferably, from 0%-to-5%, by weight, in the aggregate, of one or more auxiliary additives; and
(h) water, preferably in amount sufficient to bring the composition to 100%, all weights being based on the total weight of the final composition.

In certain aspects of the present invention, the compositions are preferably in the form of oil-continuous microemulsions.

The invention further provides such a composition particularly for cleaning hard surfaces, more particularly for cleaning vertical hard surfaces, or other surfaces, such as oven surfaces, cooktops and baking dishes, for which jobs a longer cling time for the compositions to be on the surface to be cleaned, is desired.

The cleaning compositions according to the invention may also be used in a wide variety of applications, including, but not necessarily limited to, the removal of grease, oil, ink, chewing gum, paint and polyurethane from hard and porous surfaces, including all kinds of natural and synthetic fabrics in both industrial/institutional and consumer applications. Examples of some of the other disparate types of applications include, but are not limited to, the use of the cleaning compositions according to the invention as water-rinsable paint brush cleaners for brushes having both natural and synthetic bristles, the use as a cleaner for human skin and nails, such as in a hand and fingernail cleaner for the removal of paints, greases, glues, nail polish and the like, the use as a spot cleaner for removing grease, oil, ink and paints from carpets and rugs, and as a prespotter in laundry applications for the removal of stains from fabrics. Other applications include the removal of grease, such as lithium and molybdenum greases, from steel and concrete surfaces, such as, for example, wheel bearings, or garage floors having grease- and oil-stained tire tracks, and the like. They may also be used to clean the concrete and metal surfaces of off-shore oil drilling platforms.

Examples of primary solvents which are believed to be adaptable for use in accordance with many aspects of the present invention include C₆-C₁₈, preferably C₈-C₁₂, methyl esters, C₆-C₁₈, preferably C₈-C₁₂, acetate esters, and/or C₆-C₁₈, preferably C₆-C₁₂, dibasic esters.

Examples of polar solvents that are believed to be adaptable for use in accordance with many aspects of the present invention include those having a water solubility of from about 1-to-about 8 g/100 ml, more preferably from about 1-to-about 5 g/100 ml, and even more preferably from about 2-to-about 3 g/100 ml., and may be selected from the group consisting of benzyl alcohol, ethylene glycol phenyl ether, propylene glycol phenyl ether, propylene glycol n-butyl ether, n-hexanol, n-pentanol, and the like, preferably benzyl alcohol, ethylene glycol phenyl ether or propylene glycol phenyl ether, more preferably, benzyl alcohol.

Primary emulsifiers which are believed to be readily adaptable for use in accordance with many aspects of the present invention include the amine salts of a C₁₀₋₁₄ alkyl benzene sulfonic acid, preferably an isopropanolamine salt of a linear alkylbenzene sulfonic acid, or a monoethanolamine salt of an alkyl sulfonic acid. Suitable secondary emulsifiers which are believed to be readily adaptable for use in accordance with many aspects of the present invention include those having high water solubility and HLB (hydrophile-lipophile balance) values >12, such as sodium octyl sulfate, sodium decyl sulfate, sodium lauryl sulfate, alcohol ether sulfates, octyl polyglucoside, decyl polyglucoside, lauryl polyglucoside, alcohol ethoxylates, ethoxylated triglycerides, and combinations of two or more of the above.

Suitable co-surfactants (compounds that reduce surface tension of water and are soluble in both oil and water phases) for use in accordance with many embodiments of the present invention include, but are not limited to, C₂-C₅ alcohols, glycols, glycol ethers, pyrrolidones, glycol ether esters and mixtures of two or more thereof, particularly propylene glycol n-butyl ether, dipropylene glycol n-butyl ether, and mixtures thereof.

Suitable thickening agents which may be employed in accordance with many embodiments the present invention are, in general, polymeric, including, particularly, cellulosic gum that has been hydrophobically-modified by the addition of C₃-C₆ hydrocarbon groups. Examples of such suitable thickeners include methyl cellulose, microcrystalline cellulose, povidone (PVP), pre-gelatinized starch, hydroxypropyl cellulose, hydroxypropyl methylcellulose, polyvinyl alcohol, and combinations thereof. Colloidal fused silicas and hydrophobically-modified clays are also suitable particulate thickeners. Particularly preferred thickeners are hydroxypropyl methylcellulose, hydroxypropyl cellulose, and mixtures thereof.

Optionally, auxiliaries may be incorporated into the cleaning composition of the present invention without departing from the spirit thereof. Examples of suitable auxiliary additives that may be used include, but are not limited to, pH buffering agents, corrosion inhibitors, dyes, perfumes, enzymes, preservatives, oxidizers, and the like.

Since esters are subject to hydrolysis under both acidic and alkaline conditions, it is important in many embodiments that the pH of the hard-surface cleaning composition be less than about 9, and preferably in the range of from about 4 to about 8.

The ester cleaning compositions of the present invention are preferably in the form of microemulsions, in particular, as oil-continuous microemulsions, which provides a further advantage of a high level of thermal stability, that is, at temperatures ranging from about 10° to about 70° C.

According to another embodiment of the present invention, there is provided a process for cleaning a hard surface involving contacting the hard surface with one or more of the above-disclosed emulsions, preferably in the form of liquid or spray formulations.

The present invention will be better understood by the Examples which follow, each of which is intended for illustrative purposes only, and are not meant to limit the nature or scope of the invention in any way. Unless otherwise indicated, percentages are on a weight-by-weight basis.

### EXAMPLES

Separate microemulsion cleaning compositions were prepared by combining the components listed below in the order shown with moderate agitation, and each of the resulting microemulsions in Examples 1, 2, 4 and 5 demonstrated the stability and cling necessary for their use as cleaning compositions according to the instant invention, while the composition of the comparative Example (3) could not be thickened and was not sufficiently stable to be effective on vertical surfaces.

### Example 1

| Component | | % wt. |
|---|---|---|
| a) | Water | 56.9 |
| b) | Hydroxy propyl methyl cellulose | 0.3 |
| c) | Dowanol ® PnB propylene glycol n-butyl ether | 6.0 |
| d) | Benzyl alcohol | 7.0 |
| e) | Calimulse ® PRS isopropyl amine salt of linear | 6.5 |
| | alkyl benzene sulfonic acid | |
| f) | Standapol ™ WAQ-LC sodium lauryl sulfate, 29% | 4.0 |
| g) | Texapon ® T-842 sodium n-octyl sulfate, 42% | 3.3 |
| h) | Edenor ™ ME C₆₋₁₀ methyl esters | 16.0 |

100.0

### Example 2

| Component | | % wt. |
|---|---|---|
| a) | Water | 58.7 |
| b) | Hydroxy propyl methyl cellulose | 0.3 |
| c) | Dowanol ® PnB propylene glycol n-butyl ether | 7.5 |
| d) | 2-Phenoxy ethanol | 7.0 |
| e) | Calimulse ® PRS isopropyl amine salt of linear | 7.5 |
| | alkyl benzene sulfonic acid | |
| f) | Texapon ® T-842 sodium n-octyl sulfate, 42% | 3.0 |
| g) | Edenor ™ ME C₆₋₁₀ methyl esters | 16.0 |
| | | 100.0 |

### Comparative Example 3 (Rilanit® ME-60)

| Component | | % wt. |
|---|---|---|
| a) | Edenor ™ ME C₆₋₁₀ methyl esters | 46.5 |
| b) | Calimulse ® PRS isopropyl amine salt of linear | 7.1 |
| | alkyl benzene sulfonic acid | |
| c) | Dowanol ® PnB propylene glycol n-butyl ether | 9.0 |
| d) | Standapol ™ WAQ-LC sodium lauryl sulfate, 29% | 5.3 |
| e) | Water | 32.1 |
| | | 100.0 |

### Example 4

| Component | | % wt. |
|---|---|---|
| a) | Water | 44.4 |
| b) | Hydroxy propyl methyl cellulose | 0.3 |
| c) | Short chain co-surfactant - dipropylene glycol n- | 9.0 |
| | butyl ether | |
| d) | Polar solvent - benzyl alcohol | 7.5 |
| e) | Primary emulsifier - isopropylamine salt of linear | 9.2 |
| | alkyl benzene sulfonic acid | |
| f) | Secondary emulsifier (water soluble) - Na n-octyl | 8.6 |
| | sulfate (42%) | |
| g) | Dibasic ester - mixture of dimethyl adipate and | 21.0 |
| | glutarate | |
| | | 100.0 |

### Example 5

| Component | | % wt. |
|---|---|---|
| a) | Water | 55.15 |
| b) | Hydroxy propyl methyl cellulose | 0.30 |
| c) | Dipropylene glycol n-butyl ether | 7.00 |
| d) | Linear alkyl benzene sulfonic acid | 6.70 |
| e) | Monoethanolamine | 1.35 |
| f) | Polar solvent - benzyl alcohol | 7.00 |
| g) | Dehypon ® LS 54 | 1.00 |
| h) | Texapon ® 842 Na n-octyl sulfate | 0.50 |
| i) | Exxate ® 1200 Fluid (C₁₁-C₁₄ branched alcohol, | 21.00 |
| | acetate ester) | |
| | | 100.0 |

What is claimed is:

1. A composition with vertical surface cling for cleaning hard surfaces comprising:
(a) from about 3%-to-about 50%, by weight, in the aggregate, of one or more C₆-C₁₈ primary solvents;
(b) from about 3%-to-about 15%, by weight, in the aggregate, of one or more polar solvents;
(c) from about 1%-to-about 15%, by weight, in the aggregate, of one or more primary emulsifiers;
(d) from about 1%-to-about 5%, by weight, in the aggregate, of one or more secondary emulsifiers;
(e) from about 1%-to-about 15%, by weight, in the aggregate, of one or more short-chain co-surfactants;
(f) from about 0.1%-to-about 2%, by weight, in the aggregate, of one or more thickeners; and
(g) the remainder, water, to 100%,
all weights being based on the total weight of the composition.

2. The composition according to claim 1, which includes one or more auxiliary additives selected from the group consisting of pH buffering agents, corrosion inhibitors, dyes, perfumes, enzymes, preservatives and oxidizers, in an aggregate amount up to about 5%.

3. The composition according to claim 1, wherein the one or more C₆-C₁₈ primary solvents (a) is/are selected from one or more members from group consisting of C₆-C₁₈ methyl esters, C₆-C₁₈ acetate esters, and C₆-C₁₈ dibasic esters.

4. The composition according to claim 3, wherein the one or more C₆-C₁₈ primary solvents (a) is/are selected from one or more members from the group consisting of C₈-C₁₂ methyl esters.

5. The composition according to claim 1, wherein the one or more C₆-C₁₈ primary solvents (b) is/are present in an aggregate amount of from about 15%-to-about 25%, by weight.

6. The composition according to claim 1, wherein the one or more polar solvents (b) is/are selected from the group consisting of benzyl alcohol, ethylene glycol phenyl ether, propylene glycol phenyl ether, propylene glycol n-butyl ether, and n-hexanol, and mixtures of two or more of these solvents.

7. The composition according to claim 6, wherein the one or more polar solvents (b) is/are selected from the group consisting of benzyl alcohol, ethylene glycol phenyl ether and propylene glycol phenyl ether, and mixtures of two or more of these solvents.

8. The composition according to claim 1, wherein the one or more polar solvents (b) is/are present in an aggregate amount of from about 5%-to-about 10%, by weight.

9. The composition according to claim 1, wherein the one or more primary emulsifiers (c) is/are selected from one or more amine salts of a C₁₀-C₁₄ alkyl benzene sulfonic acid.

10. The composition according to claim 9, wherein the one or more primary emulsifiers (c) is an isopropanolamine salt of a linear alkylbenzene sulfonic acid.

11. The composition according to claim 1, wherein the one or more primary emulsifiers (c) is/are present in an aggregate amount of from about 7%-to-about 10%, by weight.

12. The composition according to claim 1, wherein the one or more secondary emulsifiers (d) having an overall HLB value >12 is/are selected from the group consisting of sodium octyl sulfate, sodium decyl sulfate, sodium lauryl sulfate, alcohol ether sulfates, octyl polyglucoside, decyl polyglucoside, lauryl polyglucoside, alcohol ethoxylates, ethoxylated triglycerides and mixtures of two or more thereof, and such secondary emulsifier(s) is/are present in an aggregate amount of from about 1.9%-to-about 3.6%, by weight.

13. The composition according to claim 1, wherein the one or more short-chain co-surfactants (e) is/are selected from the group consisting of C₂-C₅ alcohols, glycols, glycol ethers, pyrrolidones, glycol ether esters and mixtures of two or more thereof, and such short-chain co-surfactant(s) is/are present in an aggregate amount of from 7%-to-10%, by weight.

14. The composition according to claim 1, wherein the one or more thickeners (f) is/are selected from the group consisting of methyl cellulose, microcrystalline cellulose, povidone, pre-gelatinized starch, hydroxypropyl cellulose, hydroxypropyl methylcellulose, colloidal fused silicas, and hydrophobically-modified clays, and mixtures of two or more thereof, and such thickeners is/are present in an aggregate amount of from about 0.2%-to-about 0.5%, by weight.

15. The composition according to claim 1 in the form of an oil-continuous microemulsion.

16. A spray-cleaning formulation comprising a composition according to claim 1.

17. A formulation for cleaning vertical hard surfaces comprising a microemulsion composition according to claim 1.

18. A process for cleaning a hard surface comprising contacting the surface with a composition comprising:
(a) from about 3%-to-about 50%, by weight, of one or more C₆-C₁₈ primary solvents;
(b) from about 3%-to-about 15%, by weight, of one or more polar solvents;
(c) from about 1%-to-about 15%, by weight, of one or more primary emulsifiers;
(d) from about 1%-to-about 5%, by weight, of one or more secondary emulsifiers;
(e) from about 1%-to-about 15%, by weight, of one or more short-chain co-surfactants;
(f) from about 0.1%-to-about 2%, by weight, of one or more thickeners;
(g) from 0%-to-about 5%, by weight, of one or more auxiliary additives; and
(h) the remainder, water, to 100%,
all weights being based on the total weight of the composition.
